(19) United States
(12) Patent Application Publication
(10) Pub. No.: US 2010/0086212 A1
(43) Pub. Date: Apr. 8, 2010

(54) Method and System for Dispositioning Defects in a Photomask

(76) Inventors: Peter Daniel Buck, Aloha, OR (US); Richard Walter Gladhill, Portland, OR (US); Roy Eric Staveley, Austin, TX (US); Joseph Adam Straub, Round Rock, TX (US); Craig Alan West, Austin, TX (US)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/524,668

(22) PCT Filed: Jan. 29, 2007
(86) PCT No.: PCT/US07/61232

§ 371 Date: Jul. 27, 2009

(51) Int. Cl. G06K 9/46

(52) U.S. Cl. 382/195

(57) ABSTRACT

A method and system for dispositioning defects in a photomask are provided. A method for dispositioning defects in a photomask includes analyzing photomask topography data including data representing a design topology of at least a first photomask, the first photomask corresponding to a first layer in a photolithographic process. Based at least on the analysis, one or more safe regions of the first photomask are identified, each safe region corresponding to a region of the first layer insensitive to potential defects located in the first photomask.

### TECHNICAL FIELD

This invention relates in general to photolithography and, more particularly, a method and system for dispositioning defects in a photomask.

### BACKGROUND

As device manufacturers continue to produce smaller and more complicated devices, photomasks used to fabricate these devices continue to require a wider range of capabilities. Photomasks, also known as reticles or masks, typically consist of substrates that have a patterned layer formed on the substrate. The patterned layer typically includes a pattern formed in an absorber material (e.g., chrome and/or other suitable materials) that represents an image that may be transferred onto a wafer in a lithography system.

Defects located on manufactured photomasks are a major source of yield loss in photomask manufacturing. For example, defects may cause errors in the transfer of an image onto a wafer in a photolithographic process. When a defect is discovered on a photomask, the defect must often be repaired or the photomask must be rejected. In certain situations, a defect may be ignored if it is determined that the defect will not adversely affect the proper functioning of the photomask or a photolithographic component (e.g., a wafer or integrated circuit) manufactured using the photomask. However, based on information provided by many currently available photomask inspection systems, it is not always evident if a particular defect will have an adverse effect.

Previous techniques for detecting non-critical defects in a photomask include the method described in U.S. Pat. No. 6,966,047. The method described therein relies on access to circuit design data corresponding to a circuit to be manufactured using a photomask set including the photomask in question. Various “flags” are set according to functionality of a circuit. These flags are then used in conjunction with an inspection tool to define different requirements for inspection criteria at the time of inspection.

From a photomask manufacturer's point of view, a problem with this approach is that it typically relies on access to the circuit pattern data in design form. Often, an owner of design data may not want to release circuit pattern data to a photomask manufacturer in design form, fearing loss of intellectual property or other undesirable results. Furthermore, this approach typically requires a specially outfitted inspection tool to make used of the flags derived from the design data.

### SUMMARY OF THE DISCLOSURE

In accordance with teachings of the present disclosure, disadvantages and problems associated with analyzing, identifying and dispositioning defects located on a photomask have been substantially reduced or eliminated. In a particular embodiment, one or more layers of a photolithographic process are analyzed to determine whether detected defects are located in a region of a photomask corresponding to a portion of a photographic process layer insensitive to defects.

In accordance with one embodiment of the present disclosure, a method for dispositioning defects in a photomask is provided. Photomask topography data including data representing a topology of at least a first photomask may be analyzed. The topology of the first photomask may correspond to a first layer in a photolithographic process. Based at least on the analysis, one or more safe regions of the first photomask may be identified, each safe region corresponding to a region of the first layer insensitive to potential defects located in the first photomask.

In accordance with another embodiment of the present disclosure, software for dispositioning defects in a photomask is provided. The software may be embodied in tangible computer readable media. When executed, the software may be operable to: analyze photomask topography data including data representing a topology of at least a first photomask, the topology of the first photomask corresponding to a first layer in a photolithographic process; and based at least on the analysis, identify one or more safe regions of the first photomask, each safe region corresponding to a region of the first layer insensitive to potential defects located in the first photomask.

In accordance with another embodiment of the present disclosure, a system for dispositioning defects in a photomask may include an analysis module and a detection module. The analysis module may be operable to analyze photomask topography data including data representing a topology of at least a first photomask may be analyzed, the topology of the first photomask corresponding to a first layer in a photolithographic process. The detection module may be operable to, based at least on the analysis, identify one or more safe regions of the first photomask, each safe region corresponding to a region of the first layer insensitive to potential defects located in the first photomask.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIG. 1 illustrates a cross-sectional view of a photomask assembly according to teachings of the present disclosure;

FIG. 2 illustrates a photolithography system that images a pattern created by a patterned layer and clear areas on a photomask onto the surface of a photolithographic component, according to teachings of the present disclosure;

FIGS. 3A-3L illustrate cross-sectional side views of a photolithographic component at various stages of manufacturing, according to the teachings of the present disclosure;

FIGS. 4A and 4B illustrate cross-sectional side views of the photolithographic component of FIG. 3L with critical defects, according to the teachings of the present disclosure;

FIG. 5 illustrates a mask layout file depicting a critical defect in a photomask corresponding to a metal layer, according to the teachings of the present disclosure;

FIG. 6 illustrates another mask layout file depicting a critical defect in a photomask corresponding to a metal layer, according to the teachings of the present disclosure;

FIG. 7 illustrates another mask layout file depicting critical defects in a photomask potentially causing harmful effects within the photomask itself, according to the teachings of the present disclosure;

FIG. 8 illustrates a mask layout file depicting a non-critical defect in a photomask corresponding to a metal layer, according to the teachings of the present disclosure;

FIG. 9 illustrates another mask layout file depicting non-critical defects in a photomask corresponding to a metal layer, according to the teachings of the present disclosure;

FIG. 10 illustrates an example system for classifying defects in a photomask, according to the teachings of the present disclosure; and

FIG. 11 illustrates an example method for classifying defects in a photomask, according to the teachings of the present disclosure.

### DETAILED DESCRIPTION

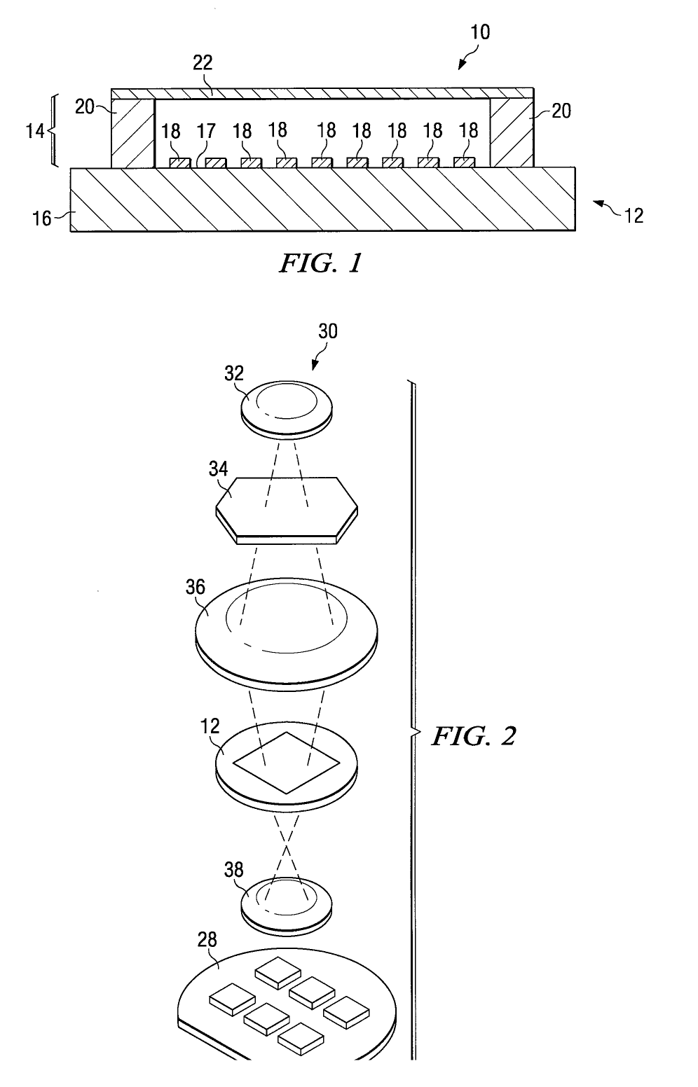

Preferred embodiments of the present disclosure and their advantages are best understood by reference to FIGS. 1 through 11, where like numbers are used to indicate like and corresponding parts.

FIG. 1 illustrates a cross-sectional view of an example photomask assembly 10. Photomask assembly 10 includes pellicle assembly 14 mounted on photomask 12. Substrate 16 and patterned layer 18 form photomask 12, otherwise known as a mask or reticle, that may have a variety of sizes and shapes, including but not limited to round, rectangular, or square. Photomask 12 may also be any variety of photomask types, including, but not limited to, a one-time master, a five-inch reticle, a six-inch reticle, a nine-inch reticle or any other appropriately sized reticle that may be used to project an image of a circuit pattern onto a semiconductor wafer. Photomask 12 may further be a binary mask, a phase shift mask (PSM) (e.g., an alternating aperture phase shift mask, also known as a Levenson type mask), an optical proximity correction (OPC) mask or any other type of mask suitable for use in a lithography system. In other embodiments, photomask 12 may be a step and flash imprint lithography (SFIL) template used to form an imprint of a pattern in a polymerizable fluid composition that solidifies to form a device on a wafer. The template may be a semi-transparent material, and the polymerizable fluid may be solidified by exposure to a radiation source in order to form the device on the wafer.

Photomask 12 includes patterned layer 18 formed on top surface 17 of substrate 16 that, when exposed to electromagnetic energy in a lithography system, projects a pattern onto a surface of a photolithographic component, e.g. a semiconductor wafer (not expressly shown). In some embodiments, substrate 16 may be a transparent material such as quartz, synthetic quartz, fused silica, magnesium fluoride (MgF₂), calcium fluoride (CaF₂), or any other suitable material that transmits at least seventy-five percent (75%) of incident light having a wavelength between approximately 10 nanometers (nm) and approximately 450 nm. In an alternative embodiment, substrate 16 may be a reflective material such as silicon or any other suitable material that reflects greater than approximately fifty percent (50%) of incident light having a wavelength between approximately 10 nm and approximately 450 nm.

In some embodiments, patterned layer 18 may be a metal material such as chrome, chromium nitride, a metallic oxy-carbo-nitride (e.g., MOₓC_{y}N_{z}, where M is selected from the group consisting of chromium, cobalt, iron, zinc, molybdenum, niobium, tantalum, titanium, tungsten, aluminum, magnesium, and silicon), or any other suitable material that absorbs electromagnetic energy with wavelengths in the ultraviolet (UV) range, deep ultraviolet (DUV) range, vacuum ultraviolet (VUV) range and extreme ultraviolet range (EUV). In an alternative embodiment, patterned layer 18 may be a partially transmissive material, such as molybdenum silicide (MoSi), which has a transmissivity of approximately one percent (1%) to approximately thirty percent (30%) in the UV, DUV, VUV and EUV ranges.

Frame 20 and pellicle film 22 may form pellicle assembly 14. Frame 20 is typically formed of anodized aluminum, although it could alternatively be formed of stainless steel, plastic or other suitable materials that do not degrade or outgas when exposed to electromagnetic energy within a lithography system. Pellicle film 22 may be a thin film membrane formed of a material such as nitrocellulose, cellulose acetate, an amorphous fluoropolymer, such as TEFLON® AF manufactured by E. I. du Pont de Nemours and Company or CYTOP® manufactured by Asahi Glass, or another suitable film that is transparent to wavelengths in the UV, DUV, EUV and/or VUV ranges. Pellicle film 22 may be prepared by a conventional technique such as spin casting, for example.

Pellicle film 22 may protect photomask 12 from contaminants, such as dust particles, by ensuring that the contaminants remain a defined distance away from photomask 12. This may be especially important in a lithography system. During a lithography process, photomask assembly 10 may be exposed to electromagnetic energy produced by a radiant energy source within the lithography system. The electromagnetic energy may include light of various wavelengths, such as wavelengths approximately between the I-line and G-line of a Mercury arc lamp, or DUV, VUV or EUV light. In operation, pellicle film 22 may be designed to allow a large percentage of the electromagnetic energy to pass through it. Contaminants collected on pellicle film 22 will likely be out of focus at the surface of the wafer being processed and, therefore, the exposed image on the wafer should be clear. Pellicle film 22 formed in accordance with the teachings of the present disclosure may be satisfactorily used with all types of electromagnetic energy and is not limited to lightwaves as described in this application.

Photomask 12 may be formed from a photomask blank using a standard lithography process. In a lithography process, a mask pattern file that includes data for patterned layer 18 may be generated from a mask layout file. In one embodiment, the mask layout file may include polygons that represent transistors and electrical connections for an integrated circuit. The polygons in the mask layout file may further represent different layers of the integrated circuit when it is fabricated on a semiconductor wafer. For example, a transistor may be formed on a semiconductor wafer with a diffusion layer and a polysilicon layer. The mask layout file, therefore, may include one or more polygons drawn on the diffusion layer and one or more polygons drawn on the polysilicon layer. In the same or alternative embodiments, the mask layout file may include polygons or shapes that represent features to be fabricated in and/or upon magnetic memory devices, micro-electrical mechanical systems (MEMS), biological MEMS (bio-MEMS), and/or optics devices.

In certain embodiments, one or more polygons in a mask layout file may not represent actual electrical, mechanical or optical components, but may be present only to assist in the lithographic process. For example, one or more polygons may comprise sub-resolution assist features (SRAFs), also known as “scattering bars,” “serifs” and/or simply “assist features,” take advantage of the fact that edges of near- and sub-wavelength features located in dense areas of a photomask are typically resolved more sharply in a photolithographic system, as compared to isolated features. Accordingly, an SRAF is a feature that may be printed on a photomask near an existing feature to improve the imaged resolution of the existing feature as if the existing feature were in a densely packed area. The SRAFs, however, may be so narrow that they do not appear on a substrate imaged by the photomask—hence the name “sub-resolution.”

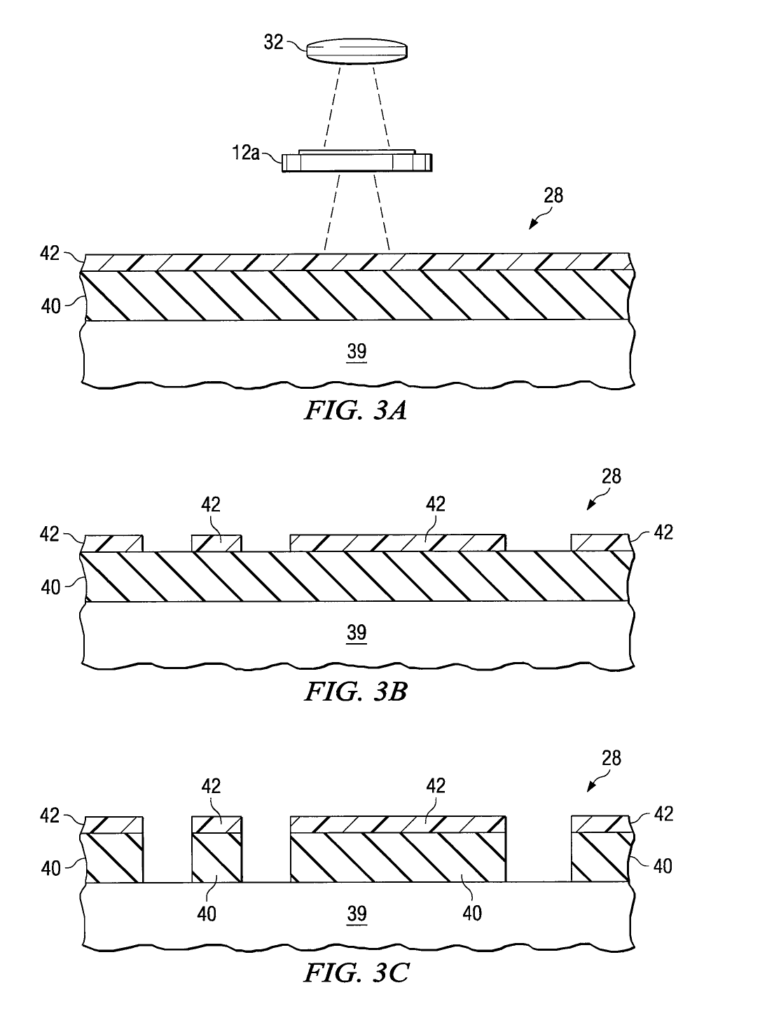

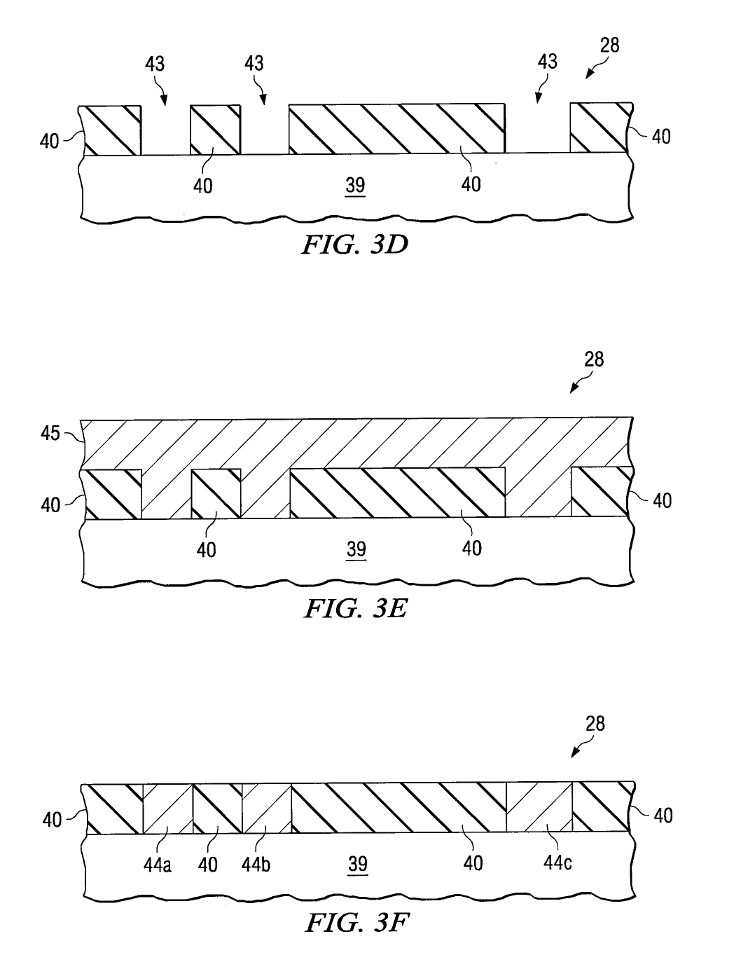

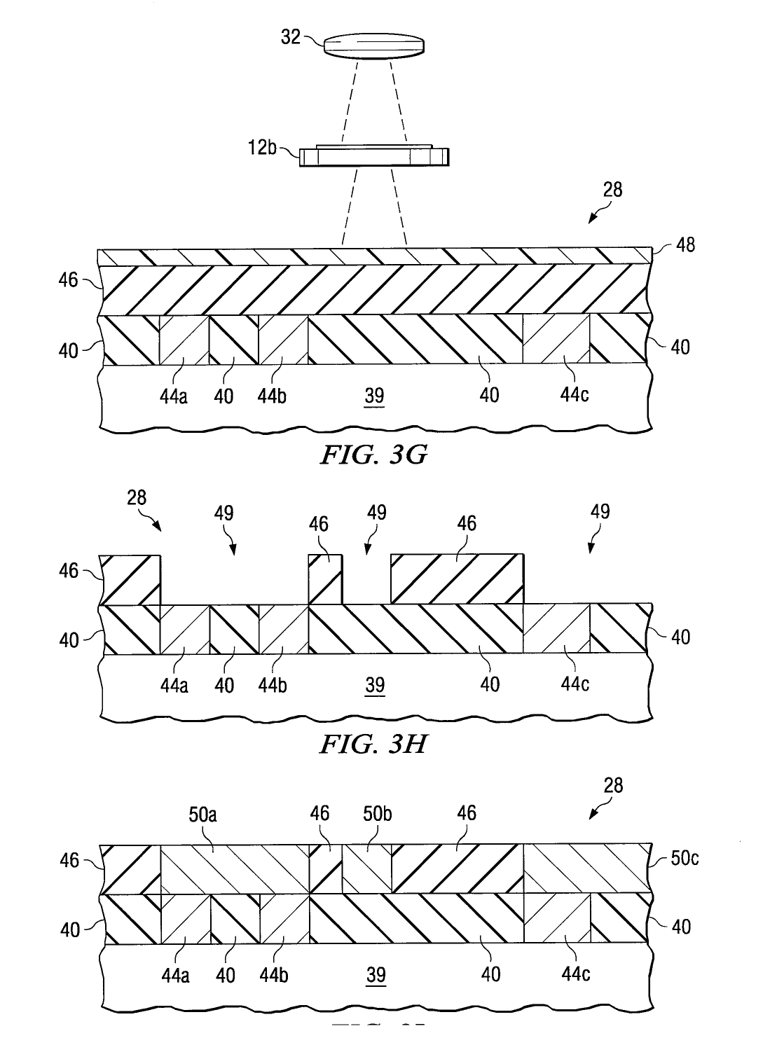

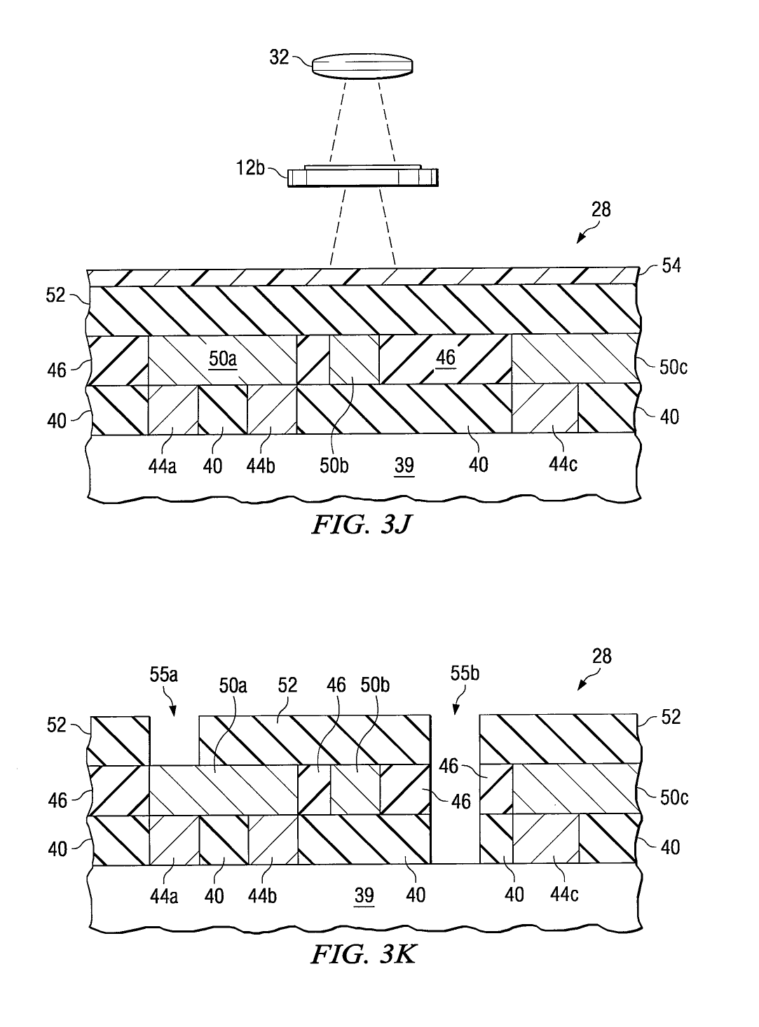

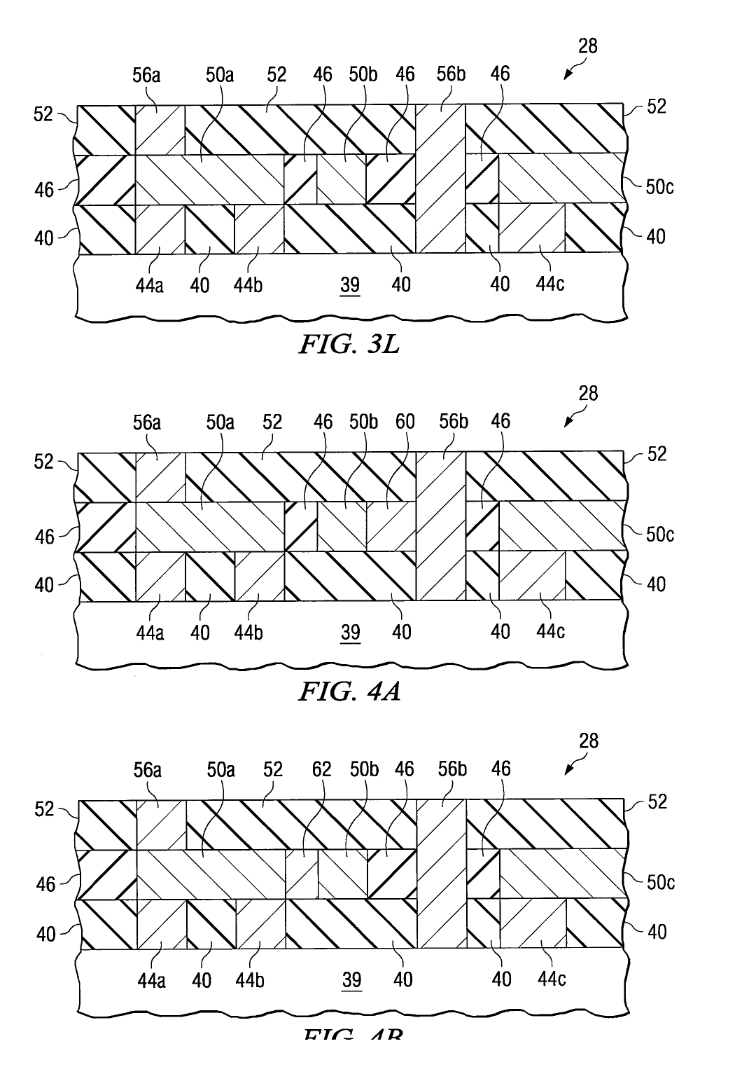

In electrical and/or integrated circuit applications, the polygons for each layer may be converted into a mask pattern file that represents one layer of an integrated circuit. In such an application, each mask pattern file may be used to generate a photomask for the specific layer. In some embodiments, the mask pattern file may include more than one layer of an integrated circuit such that a photomask may be used to image features from more than one layer onto the surface of a semiconductor wafer, as set forth in greater detail in FIGS. 2 and 3A-3L. In the same or alternative embodiments, the polygons for each layer may represent a feature to be fabricated in and/or upon magnetic memory devices, micro-electrical mechanical systems (MEMS), biological MEMS (bio-MEMS), and/or optics devices.

The desired pattern may be imaged into a resist layer of the photomask blank using a laser, electron beam or X-ray lithography system, for example. In one embodiment, a laser lithography system uses an argon-ion laser that emits light having a wavelength of approximately 364 nanometers (nm). In alternative embodiments, the laser lithography system may use lasers emitting light at wavelengths from approximately 150 nm to approximately 450 nm. In other embodiments, a 25 keV or 50 keV electron beam lithography system uses a lanthanum hexaboride or thermal field emission source. In the same or alternative embodiments, an electron beam lithography system uses a vector-shaped electronic beam lithography tool. In further embodiments, different electron beam lithography systems may be used. Photomask 12 may be fabricated by developing and etching exposed areas of the resist layer to create a pattern, etching the portions of patterned layer 18 not covered by resist, and removing the undeveloped resist to create patterned layer 18 over substrate 16.

FIG. 2 illustrates a photolithography system 30 that images a pattern created by patterned layer 18 on photomask 12 onto the surface of photolithographic component 28. Photolithography system 30 may include light source 32, filter 34, condenser lens 36 and reduction lens 38. In one embodiment, light source 32 may be a mercury vapor lamp that emits wavelengths between approximately 350 nm and 450 nm. In another embodiment, light source 32 may be an argon-ion laser that emits a wavelength of approximately 364 nm. In other embodiments, light source 32 may emit wavelengths between approximately 150 nm and approximately 350 nm. Filter 34 may select the wavelength to be used in photolithography system 30 and condenser lens 36 and reduction lens 38 may use refractive optics to focus the radiant energy from light source 32 respectively onto photomask 12 and photolithographic component 28.

During a photolithography process, electromagnetic energy may illuminate photomask 12 and an image of the pattern on photomask 12 may be projected onto photolithographic component 28. The pattern on photomask 12 may be reduced by reduction lens 38 such that the image is only projected on a portion of photolithographic component 28. Photolithography system 30 may then realign photolithographic component 28 so that the pattern from photomask 12 may be imaged onto another portion of photolithographic component 28. The process may be repeated until all or most of the surface of photolithographic component 28 is covered by multiple instances of the pattern from photomask 12.

An electronic device manufacturer may use photomask 12 to fabricate substrates using the selected etch process without having to manually adjust the etch process. For example, photomask 12 may be placed in photolithography system 30 to image a pattern onto a resist layer formed on photolithographic component 28. The areas of the resist layer that are exposed to the electromagnetic energy may then be developed and etched to expose corresponding regions of a conductive material, such as polysilicon or metal. The conductive material may be etched and the remaining resist may be removed. If the conductive material is not the last layer to be formed on photolithographic component 28, an insulating layer may be formed on the conductive layer and an additional conductive layer and resist layer may be formed on the insulating layer. The photolithography, developing, etching and depositing steps may be repeated until all layers of the semiconductor device have been formed.

In accordance with the present disclosure, photolithographic component 28 may include, without limitation, photomasks, semiconductor wafers (e.g. silicon and gallium arsenide wafers), thin film transistor array substrates (e.g. for use in the manufacture of LCDs, flat panel displays and color filters), glass masters (e.g., for use in the manufacture of compact disks and DVDs), or any other suitable substrate which can be processed using photolithography.

FIGS. 3A-3L illustrate cross-sectional side views of a photolithographic component 28 at various stages of manufacturing according to the teachings of the present disclosure. As depicted in FIG. 3A, a dielectric layer 40 may be formed over a device layer on a photolithographic component substrate 39. Furthermore, photoresist 42 may be deposited over dielectric layer 40. Dielectric layer 40 may be silicon dioxide (SiO2), a low-k interlayer dielectric (ILD) or any other suitable material that may provide an insulation layer of the integrated circuit. Substrate 39 may be silicon, gallium arsenide or any other suitable material used to form an integrated circuit and/or other structures. Photoresist 42 may be any suitable positive or negative photoresist. In order to form a desired pattern in dielectric layer 40, a photolithography system (such as photolithography system 30) including a light source 32 and photomask 12a may expose desired portions of photoresist 42 to light. Although, as depicted, photomask 12a is not coupled to a pellicle assembly, it is understood that photomask 12a may be coupled to a pellicle assembly, e.g., as shown in FIG. 1. As shown in FIG. 3B, photoresist 42 may then be developed and the developed portions of photoresist 42 removed to expose desired portions of dielectric layer 40. If a positive photoresist is used, the exposed portion of the resist may be developed and, if a negative photoresist is used, the unexposed portion of the resist may be developed.

Turning to FIG. 3C, the exposed portions of dielectric layer 40 may be removed using any suitable wet or dry etch process. As shown in FIG. 3D, an ash process may be used to remove any remaining photoresist 42, leaving trenches 43 remaining in dielectric layer 40. As shown in FIG. 3E, a metal layer 45 may be deposited in trenches 43 and over dielectric layer 40. Metal layer 45 may comprise copper, aluminum or any other suitable metal that may be used to transmit electrical signals and power among devices in an integrated circuit. As shown in FIG. 3F, a chemical mechanical polishing (CMP) process and/or other suitable process may be used such that a desired portion of metal layer 45 is removed, and the remaining portion of metal layer 45 is level with the remaining dielectric layer 40 and forms vias 44a, 44b and 44c.

As shown in FIG. 3G, a dielectric layer 46 may be formed over dielectric layer 40 and vias 44. Furthermore, photoresist 48 may be deposited over dielectric layer 46. Dielectric layer 46 may be silicon dioxide (SiO2), a low-k interlayer dielectric (ILD) or any other suitable material that may provide an insulation layer of the integrated circuit, and may be made of a material identical or similar to that of dielectric layer 40. Photoresist 48 may be any suitable positive or negative photoresist and may be made of a material identical or similar to that of photoresist 42. In order to form a desired pattern in dielectric layer 46, a photolithography system (such as photolithography system 30) including a light source 32 and photomask 12b may expose desired portions of photoresist 48 to light. Although, as depicted, photomask 12b is not coupled to a pellicle assembly, it is understood that photomask 12b may be coupled to a pellicle assembly, e.g., as shown in FIG. 1. As shown in FIG. 3H, photoresist 46 may then be developed and the developed portions of photoresist 48 removed to expose desired portions of dielectric layer 46. If a positive photoresist is used, the exposed portion of the resist may be developed and, if a negative photoresist is used, the unexposed portion of the resist may be developed. As further shown in FIG. 3H, the exposed portions of dielectric layer 46 may be removed using any suitable wet or dry etch process, and an ash process may be used to remove any remaining photoresist 48, leaving trenches 49 remaining in dielectric layer 46.

A metal layer may be deposited in trenches 49 and over dielectric layer 46. Such a metal layer may comprise copper, aluminum or any other suitable metal that may be used to transmit electrical signals and power among devices in an integrated circuit.

As shown in FIG. 31, CMP process and/or other suitable process may be used such that a desired portion of the deposited metal layer is removed, and the remaining portion of the deposited metal layer is level with the remaining dielectric layer 46 and forms metal traces 50a, 50b and 50c.

As shown in FIG. 3J, a dielectric layer 52 may be formed over dielectric layer 46 and metal traces 50. Furthermore, photoresist 54 may be deposited over dielectric layer 46. Dielectric layer 52 may be silicon dioxide (SiO2), a low-k interlayer dielectric (ILD) or any other suitable material that may provide an insulation layer of the integrated circuit, and may be made of a material identical or similar to that of dielectric layer 40 and/or dielectric layer 46. Photoresist 54 may be any suitable positive or negative photoresist and may be made of a material identical or similar to that of photoresist 42 and/or photoresist 48. In order to form a desired pattern in dielectric layer 52, a photolithography system (such as photolithography system 30) including a light source 32 and photomask 12c may expose desired portions of photoresist 54 to light. Although, as depicted, photomask 12c is not coupled to a pellicle assembly, it is understood that photomask 12c may be coupled to a pellicle assembly, e.g., as shown in FIG. 1.

As shown in FIG. 3K, photoresist 54 may then be developed and the developed portions of photoresist 54 removed to expose desired portions of dielectric layer 52. If a positive photoresist is used, the exposed portion of the resist may be developed and, if a negative photoresist is used, the unexposed portion of the resist may be developed. As further shown in FIG. 3K, the exposed portions of dielectric layer 52 may be removed using any suitable wet or dry etch process, and an ash process may be used to remove any remaining photoresist 54, leaving trenches 55a and 55b remaining in dielectric layer 52. In the embodiment depicted in FIG. 3K, some trenches 55 may be etched deeper than others. In the same or alternative embodiments, portions of a metal layer, for example metal trace 50a, may serve as an etch stop for the etch of a trench, for example trench 55a.

A metal layer may be deposited in trenches 55 and over dielectric layer 52. Such a metal layer may comprise copper, aluminum or any other suitable metal that may be used to transmit electrical signals and power among devices in an integrated circuit. As shown in FIG. 3L, A CMP process and/or other suitable process may be used such that a desired portion of the deposited metal layer is removed, and the remaining portion of the deposited metal layer is level with the remaining dielectric layer 52 and forms vias 56a and 56b. For the sake of simplicity, the present disclosure sets forth the fabrication of only those layers discussed above. However, it is understood that in accordance with the present disclosure, one or more additional layers of metallization, vias, dielectric layers and/or other layers may be added to photolithographic component 28, by repeating one or more of the steps set forth in FIGS. 3A through 3L.

FIGS. 4A and 4B each illustrate cross-sectional side views of photolithographic component 28 manufactured using a photomask, the photomask including critical defects, according to the teachings of the present disclosure. In particular, FIG. 4A depicts a critical defect 60 that causes an undesired short circuit between metal trace 50b and via 56b, which may cause circuitry formed on photolithography component 28 to operate incorrectly. Similarly, FIG. 4B depicts a critical defect 62 that creates an undesired short circuit between metal traces 50a and 50b. Critical defects 60 and 62 may be caused by a variety of factors including, without limitation, a critical defect in a photomask used to manufacture photolithographic component 28. For example, if a defect corresponding to critical defect 60 and/or 62 exists on photomask 12b, the image projected onto photoresist 48 (as shown in FIG. 3G) may expose undesired portions of photoresist 48 to light. When such exposed portions are developed and removed, undesired portions of dielectric layer 46 may be removed by etching, and undesired portions of a metal layer may be deposited in the improperly etched portions of the dielectric layer. These undesired portions of the metal layer may then cause harmful defects, such as critical defect 60 and/or 62, for example.

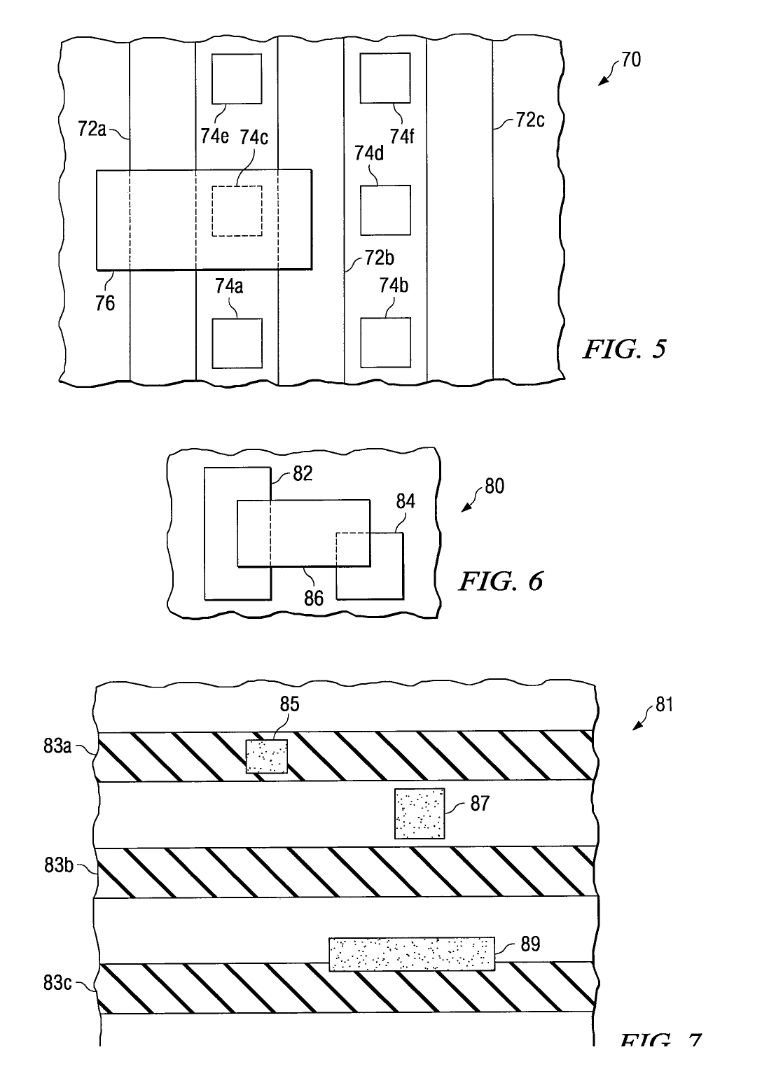

FIG. 5 illustrates a mask layout file 70 depicting an example critical defect 76 in a photomask (e.g. photomask 12), the photomask corresponding to a metal layer, according to the teachings of the present disclosure. As depicted in FIG. 5, mask layout file 70 may include metal layer polygons 72a-72c, via layer polygons 74a-74f and critical defect 76. As depicted, polygons 72a-72c correspond to metal traces to be manufactured on a metal layer of a photolithographic component (e.g., photolithographic component 28), and polygons 74a-74f correspond to vias to be manufactured on a via layer of the same photolithographic component adjacent to the metal layer. Furthermore, as depicted, polygons 72a-72c and 74a-74f correspond to metal traces and vias that are desired to be electrically isolated from one another. Critical defect 76 corresponds to an undesired defect located on a photomask corresponding to the metal layer. If a photolithographic component is manufactured according to the mask layout file using a photomask with such a. defect, undesired metallization corresponding to critical defect 76 may cause an undesired short circuit among metal traces and vias corresponding to polygons 72a, 72b and 74c, possibly leading to inoperability of a circuit associated with the photolithographic component.

FIG. 6 illustrates another mask layout file 80 depicting a critical defect 86 in a photomask (e.g. photomask 12) corresponding to a metal layer, according to the teachings of the present disclosure. As depicted in FIG. 6, mask layout file 80 may include first via layer polygon 82, second via layer polygon 84 and critical defect 86. As depicted, polygon 82 corresponds to a via to be manufactured on a first via layer of a photolithographic component (e.g., photolithographic component 28) adjacent to a metal layer, and polygon 84 corresponds to a via to be manufactured on a second via layer of the same photolithographic component adjacent to the metal layer but not adjacent to the first metal layer. Furthermore, as depicted, polygons 82 and 84 correspond to vias that are desired to be electrically isolated from one another. Critical defect 86 corresponds to an undesired defect located on a photomask corresponding to the metal layer. If a photolithographic component is manufactured according to the mask layout file using a photomask with such a defect, undesired metallization corresponding to critical defect 86 may cause an undesired short circuit between vias corresponding to polygons 82 and 84, possibly leading to inoperability of a circuit associated with the photolithographic component.

While much of the foregoing discussion has concerned photomask defects that lead to undesired results in between layers of an integrated circuit, it is understood that critical defects may also lead to undesired results within a single mask layer. FIG. 7 illustrates a mask layout file depicting examples of such single-layer critical defects. As depicted in FIG. 7, mask layout file 81 may include polygons 83a-83c and critical defects 85, 87 and 89. Polygons 83a-83c may correspond to features to be manufactured on a single layer photolithographic component. In some embodiments, polygons 83a-83c may correspond to electrical features or components in an integrated circuit (e.g., metal traces, polysilicon traces, vias, dielectrics and/or devices). In alternative embodiments, polygons 83a-83c may correspond to mechanical or biomechanical features in a MEMS or bio-MEMS device. In other embodiments, polygons 83a-83c may correspond to optical features in an optical or optoelectronic device.

Critical defects 85, 87 and 89 correspond to undesired defects located on a photomask used to image features corresponding to polygons 83a-83c. If a photolithographic component is manufactured according to mask layout file 81 using a photomask with such defects, a number of undesired effects may occur.

For example, a defect on a photolithographic component corresponding to defect 85 may cause portions of feature 83a corresponding to defect 85 to not be imaged onto a photolithographic component. However, despite the fact that defect 85 is smaller in width than feature 83a, the optical resolution limitations of a photolithography system may cause an undesired full or partial “break” in feature 83a imaged onto a photolithographic component. In integrated circuit applications, such a break may cause an undesired open circuit in the photolithographic component feature corresponding to feature 83a, possibly leading to inoperability of the integrated circuit. Such a break may also cause adverse effects in other types of applications (e.g., mechanical instability or failure in a MEMS or bio-MEMS device, optical failure in an optical or opto-electronics device).

In addition, defect 87 may cause a corresponding defect on a photolithographic component, that due to the optical resolution limitations of a photolithography system, cause photolithographic component defects corresponding to defect 87 to create an undesired “bridge” between photolithographic component features corresponding to features 83a and 83b. In integrated circuit applications, such a bridge may cause an undesired short circuit between photolithographic component features corresponding features 83a and 83b, possibly leading to inoperability of the integrated circuit. Such a bridge may also cause adverse effects in other types of applications (e.g., mechanical instability or failure in a MEMS or bio-MEMS device, optical failure in an optical or opto-electronics device).

Furthermore, a defect on a photolithographic component corresponding to defect 89 may cause an unwanted increase or decrease the size of a photolithographic component feature corresponding to feature 83c. In integrated circuit applications, such an increase or decrease in size may cause an undesired change in electrical properties of a feature (e.g., desired resistive, capacitive, inductive, conductive or insulative properties). Such a defect may also cause adverse effects in other types of applications (e.g., mechanical instability or failure in a MEMS or bio-MEMS device, optical failure in an optical or opto-electronics device).

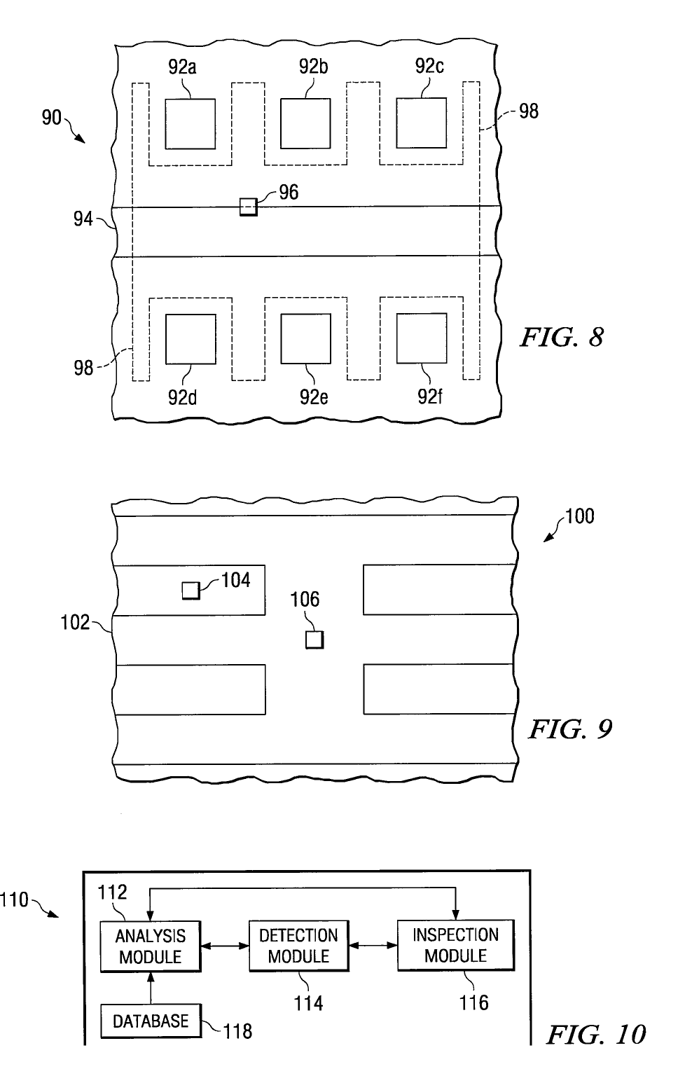

FIG. 8 illustrates a mask layout file depicting a non-critical defect 96 in a photomask (e.g. photomask 12) corresponding to a metal layer, according to the teachings of the present disclosure. As depicted in FIG. 8, mask layout file 90 may include via layer polygons 92a-92f, metal layer polygon 94, non-critical defect 96 and safe region 98. As depicted, polygon 94 corresponds to a metal trace to be manufactured on a metal layer of a photolithographic component (e.g., photolithographic component 28), and polygons 92a-92f correspond to vias to be manufactured on a via layer of the same photolithographic component adjacent to the metal layer. Furthermore, as depicted, polygons 92a-92f and 94 correspond to metal traces and vias that are desired to be electrically isolated from one another. Safe region 98 corresponds to one or more regions the metal layer which are electrically isolated from metal traces (other than the metal trace corresponding to polygon 94) and vias in the adjacent via layer. Non-critical defect 96 corresponds to an undesired defect located on a photomask corresponding to the metal layer, and falling within safe region 98. If a photolithographic component is manufactured according to the mask layout file using a photomask with such a defect, undesired metallization corresponding to non-critical defect 96 is not likely to cause an undesired short or other harmful effect, as non-critical defect 96 is located in a portion of the metal layer that is electrically isolated from metal traces in the metal layer (except for the metal trace corresponding to polygon 94) and vias in the adjacent via layer. Thus, despite the fact that non-critical defect 96 is undesired, it may not cause any defects in a photolithographic component manufactured using a photomask containing non-critical defect 96, and therefore may be ignored.

FIG. 9 illustrates another mask layout file 100 depicting non-critical defects 104 and 106 in a photomask (e.g. photomask 12) corresponding to a metal layer, according to the teachings of the present disclosure. As depicted in FIG. 9, mask layout file 100 may include metal layer polygon 102 and non-critical defects 104 and 106. As depicted, polygon 102 corresponds to a metal trace to be manufactured on a metal layer of a photolithographic component (e.g. photolithographic component 28). Furthermore, as depicted, mask layout 100 does not include polygons corresponding to any via layer or other layer adjacent to the metal layer. Non-critical defects 104 and 106 correspond to undesired defects located on a photomask corresponding to the metal layer. If a photolithographic component is manufactured according to the mask layout file using a photomask with such defects, undesired metallization corresponding to non-critical defects 104 and 106 is not likely to cause an undesired short or other harmful effect, as non-critical defects 104 and 106 are located in portions of the metal layer that are electrically isolated from any vias in an adjacent via layer. Thus, despite the fact that non-critical defects 104 and 106 are undesired, they may not cause any defects in a photolithographic component manufactured using a photomask containing non-critical defect 104 and/or 106, and therefore may be ignored.

FIG. 10 illustrates an example system 110 for dispositioning defects in a photomask, according to the teachings of the present disclosure. System 110 may comprise an analysis module 112, a detection module 114, an inspection module 116, and a database 118.

In operation, database 118 may include data representing the topography of one or more photomasks of a photomask set, each photomask corresponding to a different layer in a photolithographic process, e.g., the manufacture of photolithographic component 28. For example, system 110 may be used to disposition defects located in photomasks 12a, 12b, 12c, and/or any other photomasks used in the manufacture of photolithographic component 28, in which case data representing the topography of each of photomasks 12a, 12b, 12c and/or any other photomasks used in the manufacture of photolithographic component 28 may be written to and stored in database 118. As used in this disclosure, the term “topography” means the geometric layout and/or orientation of a patterned layer on a photomask, e.g., patterned layer 18 of photomask assembly 10.

Some or all of the data used to write database 118 may comprise and/or be constructed from data used by a photomask manufacturer to write and/or inspect the various photomasks in a photomask set. Under this approach, database 118 may be constructed using data readily available to a photomask manufacturer, and does not require pattern data in design form or access to other data sources or formats. In the same or alternative embodiments, some or all of the data used to write database 118 may comprise and/or be constructed from design data provided by the owner of the design.

Analysis module 112 may be operable to analyze photomask topography data representing topology of one or more photomasks in a photomask set to determine whether portions of one or more of the photomasks are insensitive to defects. For example, analysis module 112 may analyze photomask topology data corresponding to a first photomask and further corresponding to a first layer in a photolithographic process (for example, data corresponding to photomask 12b), and may also analyze topology data corresponding to a second photomask and further corresponding to a second layer in a photolithographic process wherein the second layer is adjacent to the first layer (for example, data corresponding to photomask 12a). In the same or alternative embodiments, analysis module 112 may also analyze topology data corresponding to a third photomask and further corresponding to a third layer in a photolithographic process wherein the third layer is adjacent to the first layer (for example, data corresponding to photomask 12c).

Once photomask topology data is analyzed by analysis module 112, detection module 114 (and/or any other component of system 110) may identify one or more safe regions of the first photomask (e.g., photomask 12b) based on at least the photomask topology data analyzed by analysis module 112. Each safe region may comprise a region of the first layer electrically insensitive to potential defects located in the first photomask. In some embodiments, detection module 114 may identify the one or more safe regions by identifying each portion of the first layer which is electrically isolated from conductive elements (e.g., vias and/or metal traces) in the second layer and/or third layer. For example, detection module 114 may identify that region 98 of FIG. 8 corresponds to a safe region of the first photomask, as region 98 is electrically isolated from conductive elements (e.g., vias 92a-92f) in adjacent layers.

In the same or alternative embodiments, detection module 114 may identify regions of a photomask layer insensitive to “breaks,” “bridges,” or other detrimental effects on the functionality of photolithographic component features. For example, detection module 114 may be able to identify portions of a photomask corresponding to mask layout file 81 of FIG. 7 that may be insensitive to defects such as defect 85 (which may potentially cause a break in feature 83a), defect 87 (which may potentially cause a break in feature 83b), and/or defect 89 (which may potentially cause undesired physical, chemical and/or electrical properties in feature 83c).

Inspection module 116 may generally be operable to detect actual defects located on a photomask. To detect defects, inspection module 116 may perform an inspection of a photomask using any suitable method or means for inspecting a photomask, e.g., photomask 12. Furthermore, inspection module 116 (or another component of system 110) may extract defect data regarding the detected defects (e.g., size, location, and/or type) via electronic means. The defect data may be communicated from inspection module 116 to analysis module 112 and/or detection module 114 for further processing and analysis. Because the defect data is extracted electronically by inspection module 116, data does not need to be manually entered into analysis module 112 or detection module 114.

In the same or alternative embodiments, analysis module 112 may also analyze the defect data communicated from inspection module 116. Based at least on the analysis of the defect data and the photomask topology data, detection module 114 may determine whether one or more of the detected actual defects (e.g., non-critical metal layer defect 96) are located in the one or more safe regions (e.g., safe region 98), and may thus disposition such defect as a non-critical defect. In the same or alternative embodiments, detection module 114, analysis module 112, and/or another component of system 110 may identify all detected metal layer defects not located in the corresponding safe region 98 of the metal layer photomask as potentially critical defects.

Although the foregoing discussion contemplates that the various modules and components of system 110 possess certain functionality, it is understood that any the functionality discussed with respect to a particular component of system 110 may in fact be undertaken by any other module or component of system 110.

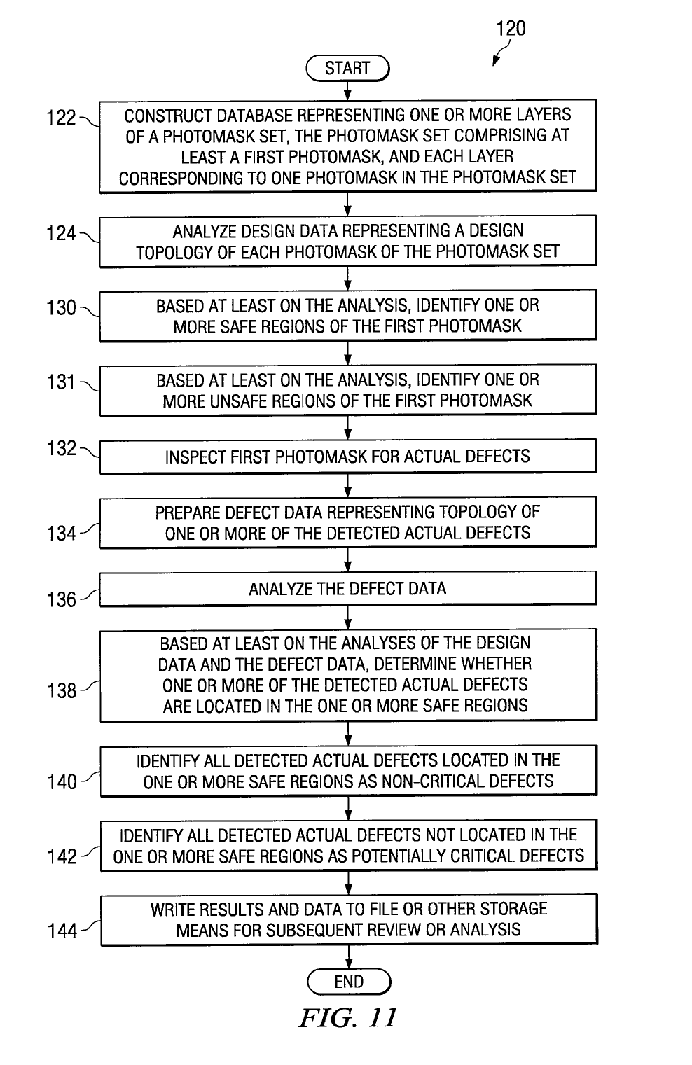

FIG. 11 illustrates an example method 120 for dispositioning defects in a photomask, according to the teachings of the present disclosure. As shown in FIG. 11, method 120 may begin at step 122. At step 122, system 110 may construct database 118 representing one or more layers of a photomask set. As discussed above, the photomask set may comprise at least a first photomask, and may comprise one or more other photomasks. Database 118 may include data representing the topography of one or more photomasks of a photomask set, each photomask corresponding to a different layer in a photolithographic process, e.g., the manufacture of photolithographic component 28. For example, method 120 may be used to disposition defects located in photomasks 12a, 12b, 12c, and/or any other photomasks used in the manufacture of photolithographic component 28, in which case data representing the topography of each of photomasks 12a, 12b, 12c and/or any other photomasks used in the manufacture of photolithographic component 28 may be written to and stored in database 118.

Proceeding to step 124, analysis module 112 may analyze photomask topography data representing a design topology of each photomask of the photomask set. For example, analysis module may analyze topology data corresponding to a first photomask and further corresponding to a first layer in a photolithographic process (for example, data corresponding to photomask 12b). Similarly, the analysis performed by analysis module 112 may also include analysis of photomask topology data corresponding to a second photomask and further corresponding to a second layer in a photolithographic process wherein the second layer is adjacent to the first layer (for example, data corresponding to photomask 12a). In the same or alternative embodiments the analysis performed by analysis module 112 may further also include analysis of photomask topology data corresponding to a third photomask and further corresponding to a third layer in a photolithographic process wherein the third layer is adjacent to the first layer (for example, data corresponding to photomask 12c).

At step 130, detection module 114 or another component of system 110 may, based at least on the analysis of step 124, identify one or more safe regions of the first photomask. In integrated circuit applications, detection module 114 may identify the one or more safe regions by identifying each portion of the first layer that is electrically isolated from conductive elements (e.g., vias and/or metal traces) in the second layer and/or third layer. For example, detection module 114 may identify that region 98 of FIG. 8 corresponds to a safe region of the first photomask, as region 98 is electrically isolated from conductive elements (e.g., vias 92a-92f) in adjacent layers. In the same of alternative embodiments, safe regions may correspond to topographic geometries that exist solely for planarization purposes and serve no electrically functional purpose in operation of circuits fabricated on photolithographic component 28. For example, mask layout file 100 depicted in FIG. 9 shows a metal trace 102 that may exist solely for planarization purposes—thus defects 104 and 106 appearing in the region shown in FIG. 9 are not connected to conductive elements in layers adjacent to the defects and thus are electrically non-functional. In such a case, defects 104 and 106 may be non-critical defects that can be ignored. In some embodiments, such electrically non-functional geometries may be identified through topological functions typically available in many EDA tools. For example, in the CALIBRE® tool available from Mentor Graphics Corporation, the NOT INTERACT command will select all the data from a given layer (e.g., the metal layer corresponding to photomask 12b) that do not share any area, edges or edge segments of another adjacent layer (e.g., vias on via layers corresponding to photomasks 12a and 12c). Conversely, areas that are sensitive to the presence of defects can be derived in a similar manner, e.g., as discussed below.

In the same or alternative embodiments, detection module 114 may, at step 130, identify regions of a photomask layer insensitive to “breaks,” “bridges,” or other detrimental effects on the functionality of photolithographic component features. For example, detection module 114 may be able to identify portions of a photomask corresponding to mask layout file 81 of FIG. 7 that may be insensitive to defects such as defect 85 (which may potentially cause a break in feature 83a), defect 87 (which may potentially cause a break in feature 83b), and/or defect 89 (which may potentially cause undesired physical, chemical and/or electrical properties in feature 83c).

Proceeding to step 131, method 120 may in some embodiments, using detection module 114, identify those areas of a photomask 12 not corresponding to a safe region as unsafe regions. At step 132, inspection module 116 may be used to inspect the first photomask for actual defects. At step 134, inspection module 116 and/or another component of system 110 may prepare defect data representing topology of one or more of the detected actual defects. The defect data may contain any relevant information regarding the detected defects, including without limitation, size, location, and/or type. In some embodiments of method 120, inspection module 116 may prepare the defect data via electronic extraction of data during the inspection at step 132. In the same or alternative embodiments, the defect data may be in a format compatible with electronic design automation (EDA) tools (e.g., OASIS™ and/or GDSII), allowing one to apply EDA tools to the manipulation and analysis of the defect data. At step 136, inspection module 116 may communicate the defect data to analysis module 112, and analysis module 112 may analyze the defect data.

At step 138, based on at least the analysis at step 136 and the analysis of step 124, detection module 114 and/or another component of system 110 may determine whether one or more of the detected actual defects (e.g., non-critical metal layer defect 96) are located in the one or more safe regions (e.g., safe region 98). In some embodiments, the defect data and the photomask topography data may be combined to allow comparison of the relative positions of the detected defects and the features defined by the photomask topography data.

At step 140, detection module 114 may identify all detected actual defects located in the one or more safe regions as non-critical defects. In some embodiments, commonly available functions in EDA tools can be used to determine whether a defect falls entirely within an area identified as insensitive to defects. For example, using CALIBRE®, the INSIDE command can be used to find all geometries on one layer (e.g., a “defect quasi-layer” represented by the defect data) that are completely within the geometries of another layer (e.g., the “quasi-layer” representing a portion of the metal layer that is within one or more of the safe regions).

Conversely, at step 142, detection module 114 may identify all detected defects not located in safe regions as potentially critical defects. At step 144, all of the foregoing results and data (the original photomask data, the safe regions, the unsafe regions, the non-critical defects, the potentially critical defects) may be written to a file or other storage means for subsequent review and/or analysis. In some embodiments the results and data may be viewed manually and/or analyzed via automated means. After completion of step 144, method 120 may end.

Although FIG. 11 discloses a particular number of steps to be taken with respect to method 120, it is understood that method 120 may be executed with greater or lesser steps than those depicted in FIG. 11. In addition, although FIG. 11 discloses a particular order of steps to be taken with respect to method 120, it is understood that steps 122-144 of method 120 may be executed in any order or manner consistent with the present disclosure. For example, in certain embodiments, steps 132-136 of method 120 may be executed prior to step 122.

Method 120 may be implemented using system 110 or any other system operable to implement method 120. In certain embodiments, method 120 may be implemented in software embodied in tangible computer readable media.

Although system 110 and method 120 are discussed primarily with reference to three layers of a photolithographic process, it is understood that the systems and methods disclosed herein may be used to analyze, identify and disposition defects in a photolithographic process comprising any number of layers. Furthermore, although system 110 and method 120 discuss the analysis, identification and disposition of defects located on a metal layer, it is understood that the systems and methods disclosed herein may be used to analyze, identify and/or disposition defects located on any photomask corresponding to any layer in a photolithographic process, including without limitation a conductive layer (e.g. a metal layer, polysilicon layer, and via layer), a dielectric layer, and a device layer (e.g. terminals of a device fabricated upon a photolithographic component) in integrated circuit applications, and/or in any layer in MEMS, bio-MEMS, optic, or opto-electronic applications.

In accordance with teachings of the present disclosure, disadvantages and problems associated with analyzing, identifying and dispositioning defects located on a photomask have been substantially reduced or eliminated. For example, the methods and systems disclosed herein do not require access to circuit pattern in design form and do not require a specially outfitted inspection tool, as required by conventional techniques.

Although the present disclosure and its advantages have been described in detail, it should be understood that various changes, substitutions and alterations can be made herein without departing from the spirit and scope of the disclosure as defined by the following claims.

What is claimed is:

1. A method for dispositioning defects in a photomask, comprising:
analyzing photomask topography data including data representing a design topology of at least a first photomask, the first photomask corresponding to a first layer in a photolithographic process; and
based at least on the analysis, identifying one or more safe regions of the first photomask, each safe region corresponding to a region of the first layer insensitive to potential defects located in the first photomask.

2. The method of claim 1, wherein the photomask topography data further includes data representing a topology of a second photomask, the topology of the second photomask corresponding to a second layer in the photolithographic process, the second layer adjacent to the first layer.

3. The method of claim 2, wherein the photomask topography data further includes data representing a topology of a third photomask, the topology of the third photomask corresponding to a third layer in the photolithographic process, the third layer adjacent to the first layer.

4. The method of claim 2, wherein the identification of the one or more safe regions comprises identifying as a safe region each portion of the first photomask corresponding to each portion of the first layer that is electrically isolated from the second layer.

5. The method of claim 1, further comprising:
inspecting the first photomask to detect actual defects located on the first photomask; and
identifying detected actual defects located in the one or more safe regions as non-critical defects.

6. The method of claim 5, further comprising:
preparing defect data representing topology of one or more of the detected actual defects;
analyzing the defect data; and
based at least on the analysis of the defect data and the analysis of the photomask topography data, identifying whether one or more of the detected actual defects are located in the one or more safe regions.

7. The method of claim 5, further comprising identifying all detected actual defects not located in the one or more safe regions as potentially critical defects.

8. The method of claim 1, wherein the photomask topography data, comprises mask layer data used to write and/or inspect one the first photomask.

9. Software for dispositioning defects in a photomask, the software embodied in tangible computer readable media and when executed operable to:
analyze photomask topography data including data representing a design topology of at least a first photomask, the first photomask corresponding to a first layer in a photolithographic process; and
based at least on the analysis, identify one or more safe regions of the first photomask, each safe region corresponding to a region of the first layer insensitive to potential defects located in the first photomask.

10. The software of claim 9, wherein the photomask topography data further includes data representing a topology of a second photomask, the topology of the second photomask corresponding to a second layer in the photolithographic process, the second layer adjacent to the first layer.

11. The software of claim 10, wherein the photomask topography data further includes data representing a topology of a third photomask, the topology of the third photomask corresponding to a third layer in the photolithographic process, the third layer adjacent to the first layer.

12. The software of claim 10, wherein the identification of the one or more safe regions comprises identifying as a safe region each portion of the first photomask corresponding to each portion of the first layer that is electrically isolated from the second layer.

13. The software of claim 9, further operable to:
analyze defect data corresponding to actual defects located on the first photomask; and
identify all detected actual defects located in the one or more safe regions as non-critical defects.

14. The software of claim 12, further operable to:
prepare the defect data to represent topology of one or more of the detected actual defects; and
based at least on the analyses of the defect data and the photomask topography data, identify whether one or more of the detected actual defects are located in the one or more safe regions.

15. The software of claim 12, further operable to identify all detected actual defects not located in the one or more safe regions as potentially critical defects.

16. The software of claim 9, wherein the photomask topography data comprises mask layer data used to write and/or inspect the first photomask.

17. A system for dispositioning defects in a photomask, comprising:
an analysis module operable to analyze photomask topography data including data representing a design topology of at least a first photomask, the first photomask corresponding to a first layer in a photolithographic process; and
a detection module operable to, based at least on the analysis, identify one or more safe regions of the first photomask, each safe region corresponding to a region of the first layer insensitive to potential defects located in the first photomask.

18. The system of claim 17, wherein the photomask topography data further includes data representing a topology of a second photomask, the topology of the second photomask corresponding to a second layer in the photolithographic process, the second layer adjacent to the first layer.

19. The system of claim 18, wherein the photomask topography data further includes data representing a topology of a third photomask, the topology of the third photomask corresponding to a third layer in the photolithographic process, the third layer adjacent to the first layer.

20. The system of claim 17, wherein the photomask topography data comprises mask layer data used to write and/or inspect the first photomask.

21. The system of claim 17, further comprising:
an inspection module operable to inspect the first photomask to detect actual defects located on the first photomask; and
the detection module further operable to identify all detected actual defects located in the one or more safe regions as non-critical defects.

22. The system of claim 21, further comprising:
the inspection module further operable to prepare defect data representing topology of one or more of the detected actual defects;
the analysis module further operable to analyze the defect data; and
the detection module further operable to, based at least on the analyses of the defect data and the photomask topography data, determine whether one or more of the detected actual defects are located in the one or more safe regions.

23. The system of claim 21, the detection module operable to identify all detected actual defects not located in the one or more safe regions as potentially critical defects.

24. The system of claim 18, wherein the identification of the one or more safe regions comprises identifying as a safe region each portion of the first photomask corresponding to each portion of the first layer that is electrically isolated from the second layer.
